(19) United States
(12) Patent Application Publication
(10) Pub. No.: US 2010/0303069 A1
(43) Pub. Date: Dec. 2, 2010

(54) SERVER, TRANSMISSION SYSTEM AND GRE TUNNEL ENCAPSULATION TRANSFERRING METHOD THEREOF

(76) Inventor: YUUSAKU HASHIMOTO, Tokyo (JP)

Correspondence Address: Mr. Jackson Chen, 6535 N. STATE HWY 161, IRVING, TX, 75039, US

(21) Appl. No.: 12/783,008

(22) Filed: May 19, 2010

(30) Foreign Application Priority Data
May 27, 2009 (JP) 127120/2009

(51) Int. Cl. H04L 12/56

(52) U.S. Cl. 370/389; 370/474

(57) ABSTRACT

A server, which has a GRE tunnel function, includes a selecting means to select any one of a layer 3 transferring method and a layer 2 transferring method, which designates a direct interface to carry out transferring, as a transferring method in the case that GRE tunnel encapsulation is carried out, and to select said layer 2 transferring method if both said transferring methods are available.

This application is based upon and claims the benefit of priority from Japanese Patent Application No. 2009-127120, filed on May 27, 2009, the disclosure of which is incorporated herein in its entirety by reference.

### TECHNICAL FIELD

The present invention relates to a server, a transmission system and a GRE (Generic Routing Encapsulation) tunnel encapsulation transferring method thereof.

### BACKGROUND ART

A NMS (Network Management System) server related to the present invention will be described with reference to a transmission system shown in FIG. 7. In FIG. 7, NMS servers 21 and 22, which are arranged in a management network 100, are connected to network devices 24 to 27, which are arranged in networks 301 and 302, via a switching apparatus 23 which is arranged in a general network 200.

The NMS servers 21 and 22 monitor a wavelength division multiplexing transmission system (for example, the network device 24 in the network 301) by use of IP (Internet Protocol) tunneling (GRE tunnel) (L3 (Layer 3) transferring method).

The GRE tunnel means a protocol by which it is possible to make a virtual point-to-point link on the IP network, and to make two routers, which are positioned at both ends of the GRE tunnel respectively, connected directly each other in one hop. A dynamic routing protocol can pass through the GRE tunnel by dynamic assignment of the IP address. Further, the GRE tunnel is disclosed in the following non-patent documents 1 and 2.

Non-patent document 1: “Generic Routing Encapsulation (GRE)” (RFC (Request For Comments) 1705, October 1994)

Non-patent document 2: “Generic Routing Encapsulation (GRE)” (RFC 2784, March 2000)

### SUMMARY

An exemplary object of the invention is to provide a server, a transmission system and a GRE tunnel encapsulation transferring method thereof, by which it is possible to avoid a problem of IP address exhaustion and to intend to make management simple when a GRE tunnel is applied.

A server according to an exemplary aspect of the invention includes:

a selector to select any one of a layer 3 transferring method and a layer 2 transferring method, which designates a direct interface to carry out transferring, as a transferring method in the case that GRE tunnel encapsulation is carried out, and to select the layer 2 transferring method if both the transferring methods are available.

A GRE tunnel encapsulation transferring method according to an exemplary aspect of the invention includes:

selecting any one of a layer 3 transferring method and a layer 2 transferring method, which designates a direct interface to carry out transferring, as a transferring method in the case that GRE tunnel encapsulation is carried out; and

selecting the layer 2 transferring method if both the transferring methods are available.

A program storing medium according to an exemplary aspect of the invention, which provides a GRE tunnel OSPF function, carry out a selecting processing of selecting any one of a layer 3 transferring method and a layer 2 transferring method, which designates a direct interface to carry out transferring, as a transferring method in the case that GRE tunnel encapsulation is carried out, and selecting the layer 2 transferring method if both the transferring methods are available.

### BRIEF DESCRIPTION OF THE DRAWINGS

Exemplary features and advantages of the present invention will become apparent from the following detailed description when taken with the accompanying drawings in which:

FIG. 1 is a block diagram showing an exemplary configuration of a NMS server according to a first exemplary embodiment of the present invention;

FIG. 2 is a block diagram showing an exemplary configuration of the NMS server according to the first exemplary embodiment of the present invention;

FIG. 3 is a flowchart showing an encapsulation processing by a GRE tunnel managing module shown in FIG. 1 and FIG. 2;

FIG. 4 is a sequence chart showing a processing which is carried out in the case that a L2 (Layer 2) transferring method is selected according to the first exemplary embodiment of the present invention;

FIG. 5 is a sequence chart showing a processing which is carried out in the case that a L3 (Layer 3) transferring method is selected according to the first exemplary embodiment of the present invention;

FIG. 6 is a block diagram showing an exemplary configuration of the NMS server according to the first exemplary embodiment of the present invention;

FIG. 7 is a block diagram showing an exemplary configuration of a GRE tunnel arranging network related to the present invention; and

FIG. 8 is a block diagram showing an exemplary configuration of a NMS server according to a second exemplary embodiment of the present invention.

### EXEMPLARY EMBODIMENT OF THE PRESENT INVENTION

Next, a detailed description will be given for a first exemplary embodiment of the present invention with reference to the drawings.

### The First Exemplary Embodiment of the Present Invention

Next, the first exemplary embodiment of the present invention will be described with reference to the drawings. First, an outline of a NMS server according to the present invention will be described.

According to the first exemplary embodiment of the present invention, the NMS server manages a wavelength division multiplexing transmission system and provides a GRE over OS PF (Open Shortest Path First) function.

With regard to an encapsulation method in the GRE over OSPF function, it is prevailing that after a packet is encapsulated, the packet is transferred to an IP module (L3 transferring method) of OS (Operating System). Then, the IP module transfers the packet with reference to an IP routing table.

On the other hand, according to the first exemplary embodiment of the present invention, the NMS server adopts a L2 transferring method, in which a packet is transferred with reference to an ARP (Address Resolution Protocol) table, as the encapsulation method in the above-mentioned GRE over OSPF function in addition to the L3 transferring method.

As a result, according to the first exemplary embodiment of the present invention, it is possible for the NMS server to select either the L2 transferring method or the L3 transferring method as the transferring method in the case that GRE tunnel encapsulation is carried out.

According to the first exemplary embodiment of the present invention, the NMS server selects either the L2 transferring method or the L3 transferring method for each module and afterward, carries out encapsulation of the packet.

As mentioned above, in case of the GRE tunnel, it is necessary to assign an IP address for a tunnel interface and an IP address for delivery. In the case that the IP address of the tunnel interface and the IP address for delivery use the same IP address in the L3 transferring method, an infinite loop is caused since a destination address of the encapsulated packet is coincident on the routing table.

In contrast, since the L2 transferring method, which can be selected according to the exemplary embodiment of the present invention, does not use the routing table for transferring the packet, it is possible to avoid the problem that the infinite loop is caused. That is, it is possible to make the IP address of the tunnel interface and the IP address for delivery identical each other in the case of the L2 transferring method.

Therefore, according to the NMS server of the first exemplary embodiment of the present invention, since it is possible to make the IP address of the tunnel interface and the IP address for delivery identical each other through selecting the L2 transferring method, it is unnecessary to assign an additional IP address. Therefore, it is possible to avoid the IP address exhaustion.

According to the first exemplary embodiment of the present invention, a new IP address is not used through using the IP address of the physical interface of the NMS server which has the GRE over OSPF function mentioned above.

A procedure, in which the tunnel is arranged between the NMS server and the wavelength division multiplexing transmission system, will be described in the following.

a) The wavelength division multiplexing transmission system, which is placed on the opposite side from the NMS server, is selected.

b) The tunnel interface and the delivery header IP address are determined.

c) The destination address and the source address, which are designated for the tunnel interface, are registered in the routing table.

d) Either the L3 transferring method or the L2 transferring method is selected. Then, the packet is encapsulated to be transferred.

In order to transfer the packet, the IP module of OS is adopted usually. However, according to the present invention, the IP module is not used, but a RAW socket transferring method, which transfers a packet through designating a direct interface, is adopted.

According to the first exemplary embodiment of the present invention, it is possible to select either the L2 transferring method or the L3 transferring method as the transferring method in the case that the GRE tunnel encapsulation is carried out, as mentioned above. Since it is possible to make the IP address of the tunnel interface and the IP address for delivery identical each other in the case that the L2 transferring method is selected, it is unnecessary to assign an additional IP address. It is possible to avoid the problem of IP address exhaustion and to make management simple by virtue of the feature according to the first exemplary embodiment of the present invention.

Next, details of an operation according to the first exemplary embodiment of the present invention will be described with reference to drawings.

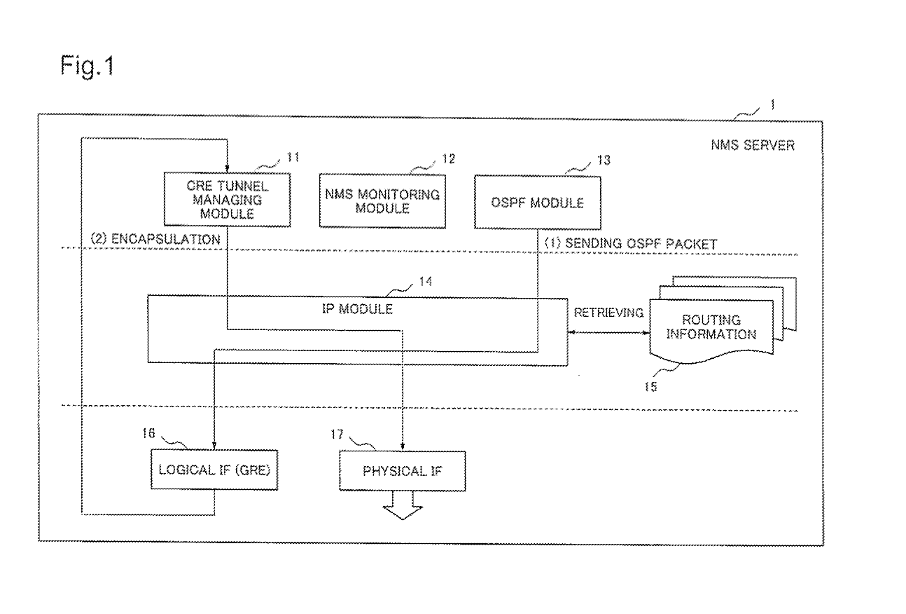

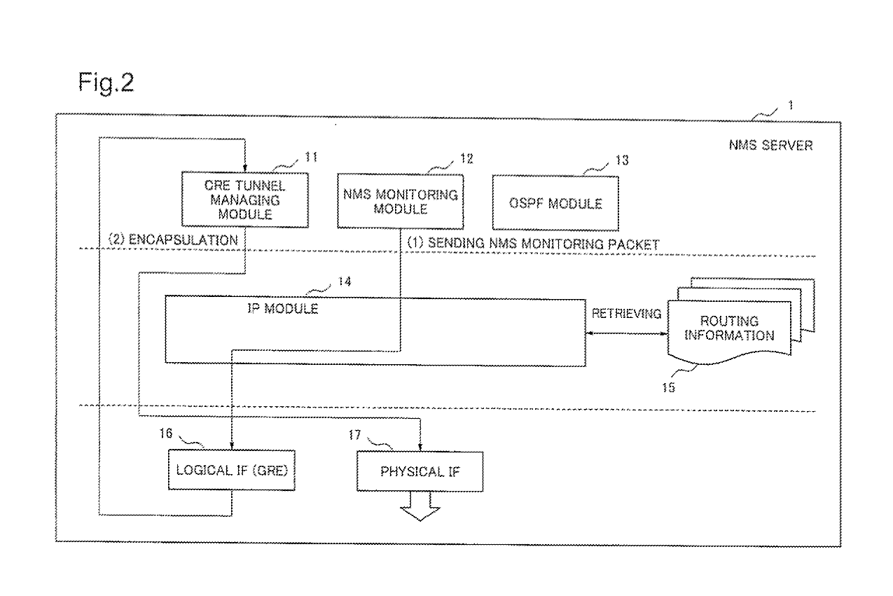

FIG. 1 and FIG. 2 are block diagrams showing exemplary configurations of the NMS server according to the first exemplary embodiment of the present invention. FIG. 1 shows an example of arranging the GRE tunnel based on the GRE encapsulation (L3 transferring method), and FIG. 2 shows an example of arranging the GRE tunnel based on the GRE encapsulation (L2 transferring method).

As shown in FIG. 1 and FIG. 2, a NMS server 1 includes a GRE tunnel managing module 11, a NMS monitoring module 12, an OSPF module 13, an IP module 14, a routing table 15 and a logical I/F (Interface) (GRE) 16 and a physical I/F 17 according to the first exemplary embodiment of the present invention.

According to FIG. 1, the OSPF module 13 sends an OSPF packet to the IP module 14 ((1) in FIG. 1). The IP module 14 transfers the OSPF packet to the tunnel interface (logical I/F 16) with reference to the routing table 15.

The GRE tunnel managing module 11 receives the OSPF packet, which is transferred from the tunnel interface (logical I/F 16), and determines which transferring method is selected out of the L2 transferring method and the L3 transferring method. Since the packet is the OSPF packet in this case, the GRE tunnel managing module 11 selects the L3 transferring method and encapsulates the OSPF packet ((2) in FIG. 1) and transfers the encapsulated packet to the IP module 14.

The IP module 14 transfers the encapsulated packet to the appropriate interface (physical I/F 17) with reference to the routing table 15.

According to FIG. 2, the NMS monitoring module 12 sends a monitoring packet of the wavelength division multiplexing transmission system to the IP module 14 ((1) of FIG. 2). The IP module 14 transfers the monitoring packet to the tunnel interface (logical I/F 16) with reference to the routing table 15.

The GRE tunnel managing module 11 receives the monitoring packet, which is transferred from the tunnel interface (logical I/F 16), and determines which transferring method is selected out of the L2 transferring method and the L3 transferring method. Since the packet is the monitoring packet in this case, the GRE tunnel managing module 11 selects the L2 transferring method and encapsulates the monitoring packet ((2) in FIG. 2) and transfers the encapsulated packet from the designated interface (physical I/F 17) directly, that is, not via the IP module 14.

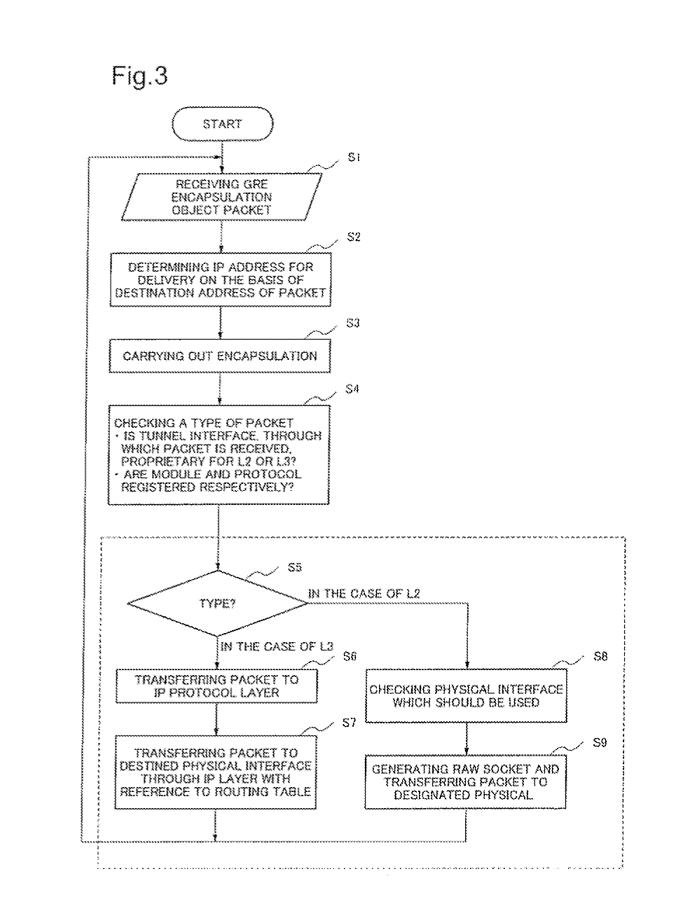

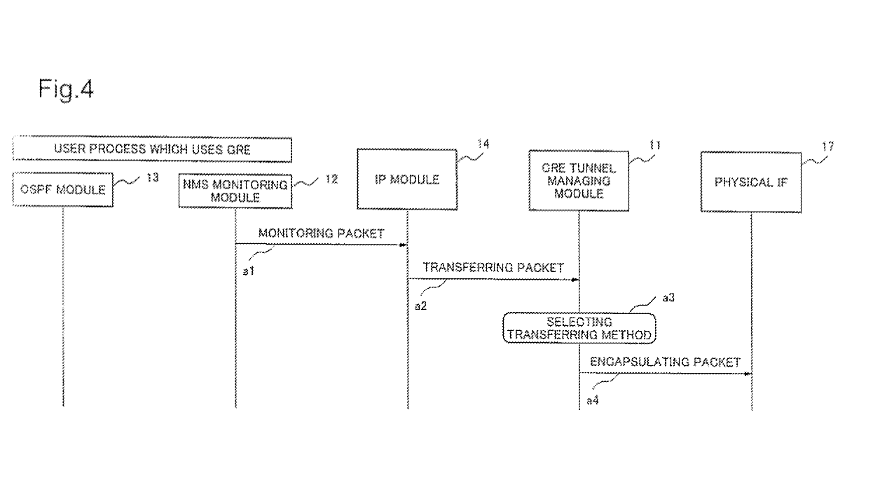

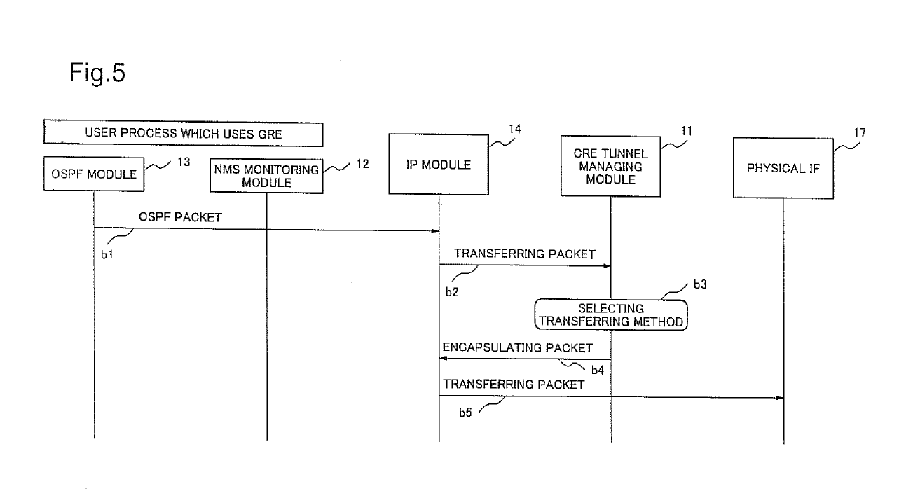

FIG. 3 is a flowchart showing the encapsulation processing of the GRE tunnel managing module 11 shown in FIG. 1 and FIG. 2. FIG. 4 is a sequence chart showing a processing in the case that the L2 transferring method is selected according to the first exemplary embodiment of the present invention. FIG. 5 is a sequence chart showing a processing in the case that the L3 transferring method is selected according to the first exemplary embodiment of the present invention. A processing, which is carried out in the case that either the L2 transferring method or the L3 transferring method is selected, will be described in the following with reference to FIGS. 1 to 5 according to the first exemplary embodiment of the present invention.

The NMS monitoring module 12 sends the monitoring packet of the wavelength division multiplexing transmission system to the IP module 14 ((1) in FIGS. 2 and a1 in FIG. 4). The IP module 14 transfers the monitoring packet to the tunnel interface (logical I/F 16) with reference to the routing table 15.

The GRE tunnel managing module 11 receives the monitoring packet which is transferred from the tunnel interface (logical I/F 16) (a2 in FIG. 4), and determines which transferring method is selected out of the L2 transferring method and the L3 transferring method (a3 in FIG. 4).

In the case that the GRE tunnel managing module 11 carries out the encapsulation processing, the GRE tunnel managing module 11 receives an encapsulation object packet from the tunnel interface (logical I/F 16) (step S1 in FIG. 3). Afterward, the GRE tunnel managing module 11 determines the delivery header address on the basis of the destination address of the packet (step S2 in FIG. 3) and carries out encapsulating the packet ((2) in FIG. 2 and step S3 in FIG. 3).

In the case, the GRE tunnel managing module 11 checks whether the generated GRE tunnel interface is registered as either the L2 transferring method or the L3 transferring method (step S4 in FIG. 3). In the case of a proprietary L2 or a proprietary L3, a L2 transferring packet is discarded even if the L2 transferring packet is received.

The GRE tunnel managing module 11 carries out to transfer the packet by use of the L2 transferring method or the L3 transferring method per the registered module or the registered protocol. In the case of the L2 transferring method, the GRE tunnel managing module 11 checks the physical I/F 17 which should be used (step S8 in FIG. 3) and generates the RAW socket and transfers the packet to the designated physical I/F 17 directly (step S9 in FIG. 3) (a4 in FIG. 4).

Further, the GRE tunnel managing module 11 discards the packet which is not registered.

Moreover, the GRE tunnel managing module 11 checks whether the packet is related to the registered module on the basis of a proprietary primitive header. Moreover, the GRE tunnel managing module 11 checks the protocol of the packet on the basis of protocol number of the IP header to identify the protocol.

Meanwhile, in the case that the OSPF module 13 sends the OSPF packet to the IP module 14 ((1) in FIGS. 1 and b1 in FIG. 5), the IP module 14 transfers the OSPF packet to the tunnel interface (logical I/F 16) with reference to the routing table 15.

The GRE tunnel managing module 11 receives the OSPF packet, which is transferred from the tunnel interface (logical I/F 16) (b2 in FIG. 5), and determines which transferring method is selected out of the L2 transferring method and the L3 transferring method.

In the case that the GRE tunnel managing module 11 carries out the encapsulation processing, the GRE tunnel managing module 11 receives the encapsulation object packet from the tunnel interface (logical I/F 16) (step S1 in FIG. 3). Afterward, the GRE tunnel managing module 11 determines the delivery header address on the basis of the destination address of the packet (step S2 in FIG. 3) and carries out encapsulating the packet ((2) in FIG. 2 and step S3 in FIG. 3).

The GRE tunnel managing module 11 checks whether the generated GRE tunnel interface is registered as the L2 transferring method or the L3 transferring method (step S4 in FIG. 3). In the case of the proprietary L2 transferring method or the proprietary L3 transfer method, the packet based on the different transferring method is discarded even if the packet based on the different transferring method is received.

The GRE tunnel managing module 11 carries out to transfer the packet by use of the L2 transferring method or the L3 transferring method per the registered module or the registered protocol. In the case of the L3 transferring method (step S5 in FIG. 3), the GRE tunnel managing module 11 transfers the encapsulated packet to the IP module 14 (IP protocol layer) (steps S6 in FIGS. 3 and b4 in FIG. 5) and then, the IP module 14 (IP protocol layer) transfers the encapsulated packet to the corresponding physical I/F 17 with reference to the routing table 15 (step S7 in FIGS. 3 and b5 in FIG. 5).

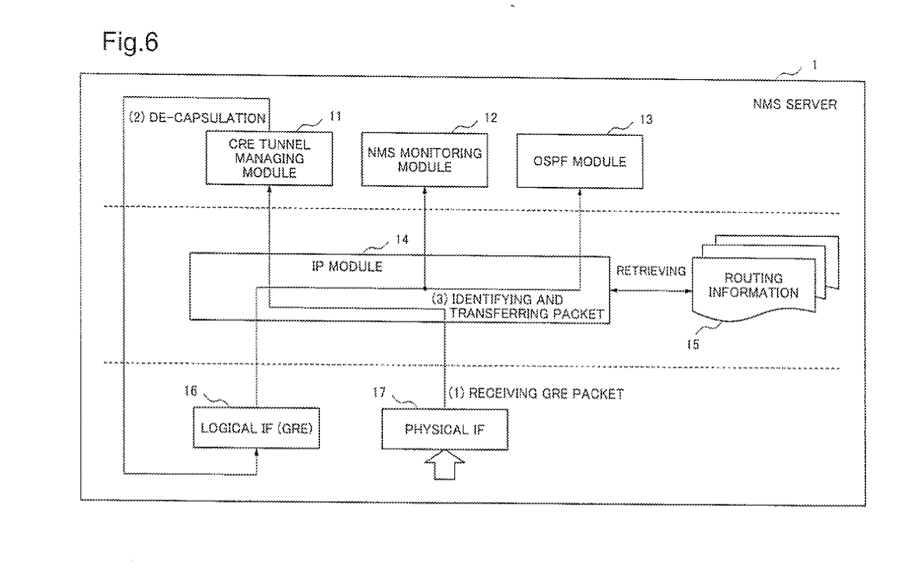

FIG. 6 is a block diagram showing an exemplary configuration of the NMS server according to the first exemplary embodiment of the present invention. FIG. 6 shows an example of GRE de-capsulation. Hereinafter, the GRE de-capsulation will be described with reference to FIG. 6 according to the first exemplary embodiment of the present invention.

When the physical I/F 17 receives the GRE packet ((1) in FIG. 6), the physical I/F 17 transfers the packet to the IP module 14. The IP module 14 checks the protocol number of the packet. In the case of the GRE packet, the IP module 14 transfers the GRE packet to the GRE managing module 11.

The GRE managing module 11 de-capsulates the encapsulated GRE packet ((2) in FIG. 6), and transfers a packet, which is corresponding to a payload of encapsulated GRE packet, to the IP module 14 via the logical I/F 16. The IP module 14 delivers the payload packet to the corresponding module (NMS monitoring module 12 or OSPF module 13).

Thus, according to the first exemplary embodiment of the present invention, it is possible to select the transferring method of the GRE tunnel encapsulation (L2 transferring method or L3 transferring method) on the basis of network environment and application to be used (user process).

According to the first exemplary embodiment of the present invention, since it is possible to make the IP address of the tunnel interface and the IP address for delivery identical each other in the case of selecting the L2 transferring method, it is unnecessary to assign an additional IP address. It is possible to avoid the problem of IP address exhaustion and to make management simple by virtue of the feature according to the first exemplary embodiment of the present invention.

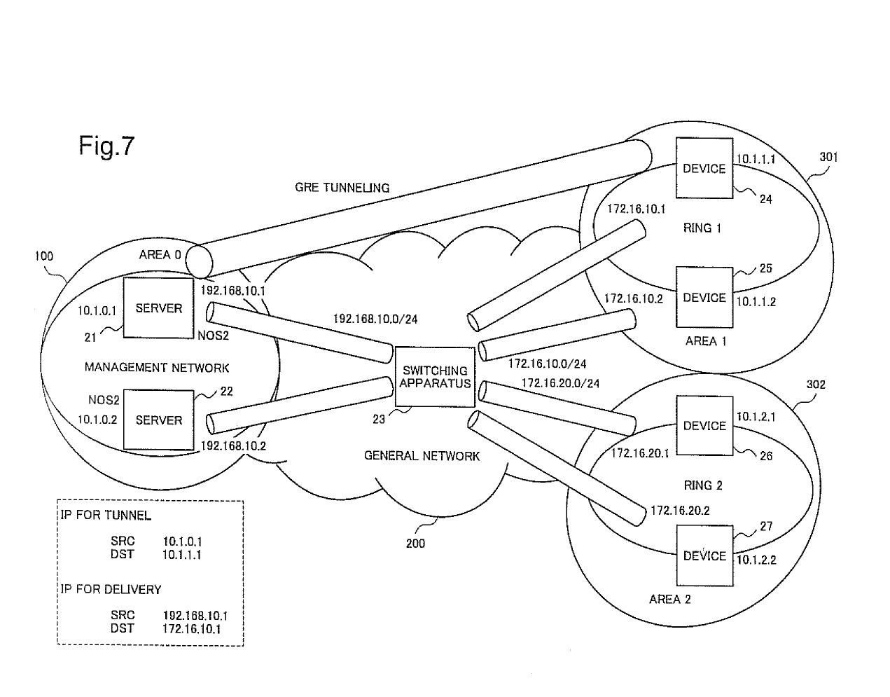

Further, while not being illustrated, the first exemplary embodiment of the present invention can be applied to monitoring the wavelength division multiplexing transmission system shown in FIG. 7.

While two types of packets, that is, the monitor packet originated from the NMS monitoring module 12 and the OSPF packet originated from the OSPF module 13 are shown according to the first exemplary embodiment of the present invention, the packet according to the present invention is not limited to these packets.

Moreover, it may be preferable that the L2 transferring method is used dependently on a situation, in the case that the L2 transferring method is available.

### A Second Exemplary Embodiment of the Present Invention

The second exemplary embodiment of the present invention will be described in the following with reference to drawings.

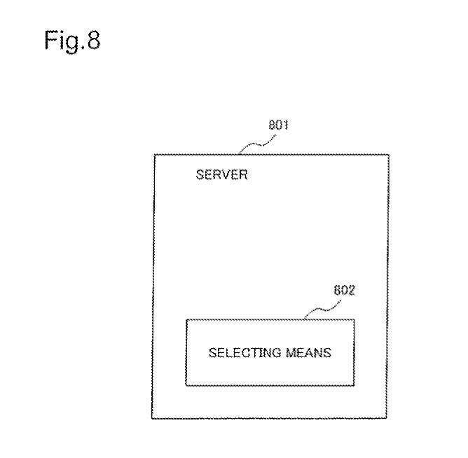

FIG. 8 is a block diagram showing an exemplary configuration of a NMS server according to the second exemplary embodiment of the present invention. Codes 801 and 802 denote the NMS server and a selecting means respectively.

According to the second exemplary embodiment of the present invention, the NMS server 801 manages a wavelength division multiplexing transmission system and provides the layer 3 transferring method with which a packet is encapsulated and afterward, the encapsulated packet is transferred with reference to an IP routing table.

The server can select the layer transferring method to transfer the packet to a direct interface, which is designated with reference to an ARP table, as the encapsulation method in the GRE over OSPF function. Moreover, the server has the selecting means 802 which selects either the layer 3 transferring method or the layer 2 transferring method as the transferring method in the case that the GRE tunnel encapsulation is carried out.

Therefore, it is unnecessary to assign a new IP address by use of L2 transferring method and consequently, and it is possible to avoid the IP address exhaustion. Therefore, according to the second exemplary embodiment of the present invention, it is possible to avoid the problem of IP address exhaustion and to intend to make management simple in the case that the GRE tunnel is adopted.

### A Third Exemplary Embodiment of the Present Invention

According to the third exemplary embodiment of the present invention, a server manages a wavelength division multiplexing transmission system and adopts the L3 transferring method with which a packet is encapsulated and afterward, the encapsulated packet is transferred with reference to an IP routing table. The server provides the GRE over OSPF function. The server can select the L2 transferring method to transfer the packet to a direct interface, which is designated with reference to an ARP table, as the encapsulation method in the GRE over OSPF function. Moreover, the server has a selecting means which selects either the layer 3 transferring method or the L2 transferring method as the transferring method in the case that the GRE tunnel encapsulation is carried out.

### A Fourth Exemplary Embodiment of the Present Invention

A GRE encapsulation transferring method according to the fourth exemplary embodiment of the present invention is used in a server which manages a wavelength division multiplexing transmission system and provides the GRE over OSPF function adopting the L3 transferring method of encapsulating a packet and of transferring afterward the encapsulated packet with reference to an IP routing table. In addition to the layer 3 transferring method, the GRE encapsulation transferring method includes the layer 2 transferring method to transfer a packet to a direct interface, which is designated with reference to an ARP table, as the encapsulation method in the GRE over OSPF function. Then, the server carries out a selecting processing to select either the layer 3 transferring method or the layer 2 transferring method as the transferring method in the case that the GRE tunnel encapsulation is carried out.

In the case of monitoring of the wavelength division multiplexing transmission system in related art, a monitoring area and a general area may be mixed together in a monitoring network in some cases.

In the case of the network in which the monitoring area and the general area are mixed together, there are two methods not to disclose the monitoring information to the general area, that is, one is a method which uses OS1 (Open Systems Interconnection) protocol and the other is a method which uses IP tunneling such as the GRE tunnel or the like. However, the IP tunneling becomes prevailing recently rather than OSI protocol.

The GRE tunnel is one of tunnel protocols to realize transmitting packets, which are based on different protocols, within the tunnel. A packet (traffic), which passes through the tunnel, is permitted to pass through an interface for the tunnel and then, the packet is encapsulated to be transmitted as the different protocol.

According to the GRE tunnel function, it is necessary to set the following IP address so as to generate the tunnel interface.

a) Tunnel interface IP address which is a new IP address assigned for the tunnel interface:

According to the GRE tunnel, it is necessary to set a pair of addresses shown in the following in order to make a point-to-point type tunnel.

a-1) Destination address (Destination);

a-2) Source address (Source);

b) Delivery header IP address which is used at a time when a packet, to which the GRE tunnel encapsulation should be carried out, is encapsulated: Specifically, it is necessary to set a pair of addresses shown in the following.

b-1) Destination address (Destination);

b-2) Source address (Source);

The GRE tunnel is adopted for monitoring the wavelength division multiplexing transmission system in related art. Therefore, it is necessary to assign an additional new IP address, which is shown in a), in order to monitor the wavelength division multiplexing transmission system which uses the GPE tunnel. Therefore, it is necessary for an operator to carry out a management to set the GRE tunnel and to assign the IP address etc. There is also a possibility that the problem of IP address exhaustion is caused.

By virtue of the configuration and the operation mentioned above, the present invention has an effect that, in case of using the GRE tunnel, it is possible to avoid the problem of IP address exhaustion, and to intend to make the management simple.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### Further Exemplary Embodiment 1

A server which provides a GRE tunnel function, comprising:

a selecting means to select any one of a layer 3 transferring method and a layer 2 transferring method, which designates a direct interface to carry out transferring, as a transferring method in the case that GRE tunnel encapsulation is carried out, and to select said layer 2 transferring method if both said transferring methods are available.

### Further Exemplary Embodiment 2

The server according to Further exemplary embodiment 1, wherein
said layer 2 transferring method designates a direct interface with reference to an ARP table and carries out transferring.

### Further Exemplary Embodiment 3

The server according to Further exemplary embodiment 2, wherein

said server carries out transferring a packet by use of said layer 2 transferring method or said layer 3 transferring method per a registered module or a registered protocol.

### Further Exemplary Embodiment 4

The server according to Further exemplary embodiment 3, wherein

said server checks whether a module is incident to said registered module on the basis of a primitive header and checks whether a protocol is incident to said registered protocol on the basis of protocol number of an IP header.

### Further Exemplary Embodiment 5

The server according to Further exemplary embodiment 1, wherein

said selecting means selects any one of said layer 2 transferring method and said layer 3 transferring method for a packet and afterward, carries out GRE tunnel encapsulation for said packet.

### Further Exemplary Embodiment 6

The server according to Further exemplary embodiment 1, wherein

said server is a NMS server for monitoring said wavelength division multiplexing transmission system.

### Further Exemplary Embodiment 7

A transmission system which includes a server described in any one of Further exemplary embodiments 1 to 6.

### Further Exemplary Embodiment 8

A GRE tunnel encapsulation transferring method which is used in a server providing a GRE tunnel function, comprising:

selecting any one of a layer 3 transferring method and a layer 2 transferring method, which designates a direct interface to carry out transferring, as a transferring method in the case that GRE tunnel encapsulation is carried out; and

selecting said layer 2 transferring method if both said transferring methods are available.

### Further Exemplary Embodiment 9

The GRE tunnel encapsulation transferring method according to Further exemplary embodiment 8, wherein

said layer 2 transferring method designates a direct interface with reference to an ARP table and carries out transferring.

### Further Exemplary Embodiment 10

The GRE tunnel encapsulation transferring method according to Further exemplary embodiment 9, wherein

said server carries out transferring a packet by use of said layer 2 transferring method or said layer 3 transferring method per a registered module or a registered protocol.

### Further Exemplary Embodiment 11

The GRE tunnel encapsulation transferring method according to Further exemplary embodiment 10, wherein

said server checks whether a module is incident to said registered module on the basis of a primitive header and checks whether a protocol is incident to said registered protocol on the basis of protocol number of an IP header.

### Further Exemplary Embodiment 12

The GRE tunnel encapsulation transferring method according to Further exemplary embodiment 11, wherein

said server selects any one of said layer 2 transferring method and said layer 3 transferring method for a packet and afterward, carries out GRE tunnel encapsulation for said packet.

### Further Exemplary Embodiment 13

The GRE tunnel encapsulation transferring method according to any one of Further exemplary embodiment 8 to Further exemplary embodiment 12, wherein

said server is a NMS server for monitoring said wavelength division multiplexing transmission system.

### Further Exemplary Embodiment 14

A program storing medium storing a program which makes a computer as a server, which provides a GRE tunnel OSPF function, carry out a selecting processing of selecting any one of a layer 3 transferring method and a layer 2 transferring method, which designates a direct interface to carry out transferring, as a transferring method in the case that GRE tunnel encapsulation is carried out, and selecting said layer 2 transferring method if both said transferring methods are available.

1. A server which provides a GRE tunnel function, comprising:
a selecting means to select any one of a layer 3 transferring method and a layer 2 transferring method, which designates a direct interface to carry out transferring, as a transferring method in the case that GRE tunnel encapsulation is carried out, and to select said layer 2 transferring method if both said transferring methods are available.

2. The server according to claim 1, wherein
said layer 2 transferring method designates a direct interface with reference to an ARP table and carries out transferring.

3. The server according to claim 2, wherein
said server carries out transferring a packet by use of said layer 2 transferring method or said layer 3 transferring method per a registered module or a registered protocol.

4. The server according to claim 3, wherein
said server checks whether a module is incident to said registered module on the basis of a primitive header and checks whether a protocol is incident to said registered protocol on the basis of protocol number of an IP header.

5. The server according to claim 1, wherein
said selecting means selects any one of said layer 2 transferring method and said layer 3 transferring method for a packet and afterward, carries out GRE tunnel encapsulation for said packet.

6. The server according to claim 1, wherein
said server is a NMS server for monitoring said wavelength division multiplexing transmission system.

7. A transmission system which includes a server described in claim 1.

8. A GRE tunnel encapsulation transferring method which is used in a server providing a GRE tunnel function, comprising:
selecting any one of a layer 3 transferring method and a layer 2 transferring method, which designates a direct interface to carry out transferring, as a transferring method in the case that GRE tunnel encapsulation is carried out; and
selecting said layer 2 transferring method if both said transferring methods are available.

9. The GRE tunnel encapsulation transferring method according to claim 8, wherein
said layer 2 transferring method designates a direct interface with reference to an ARP table and carries out transferring.

10. The GRE tunnel encapsulation transferring method according to claim 9, wherein
said server carries out transferring a packet by use of said layer 2 transferring method or said layer 3 transferring method per a registered module or a registered protocol.

11. The GRE tunnel encapsulation transferring method according to claim 10, wherein
said server checks whether a module is incident to said registered module on the basis of a primitive header and checks whether a protocol is incident to said registered protocol on the basis of protocol number of an IP header.

12. The GRE tunnel encapsulation transferring method according to claim 11, wherein
said server selects any one of said layer 2 transferring method and said layer 3 transferring method for a packet and afterward, carries out GRE tunnel encapsulation for said packet.

13. The GRE tunnel encapsulation transferring method according to claim 8, wherein
said server is a NMS server for monitoring said wavelength division multiplexing transmission system.

14. A program storing medium storing a program which makes a computer as a server, which provides a GRE tunnel OSPF function, carry out a selecting processing of selecting any one of a layer 3 transferring method and a layer 2 transferring method, which designates a direct interface to carry out transferring, as a transferring method in the case that GRE tunnel encapsulation is carried out, and selecting said layer 2 transferring method if both said transferring methods are available.
